(19) United States
(12) Patent Application Publication
(10) Pub. No.: US 2006/0125372 A1
(43) Pub. Date: Jun. 15, 2006

(54) Phosphor screen with metal back, method of forming the same and image display unit

(75) Inventors: Hajime Tanaka, Fujioka-shi (JP); Takeo Ito, Kumagaya-shi (JP); Tomoko Nakazawa, Maebashi-shi (JP); Masaaki Inamura, Fukaya-shi (JP); Masayuki Yoshii, Fukaya-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 10/532,980

(22) PCT Filed: Oct. 29, 2003
(86) PCT No.: PCT/JP03/13823

§ 371 Date: Oct. 21, 2005

(51) Int. Cl. H01J 29/10

(52) U.S. Cl. 313/473

(57) ABSTRACT

A metal back-attached phosphor screen comprises at least a phosphor layer (3) and a metal back layer (5) on an inner surface of a face plate (1), a first treatment layer (4) containing at lest one kind of inorganic oxide such as SiO₂,a silicon oxide containing an alkali metal such as Na, Al₂O₃, TiO₂, or ZrO₂ formed on the phosphor layer (3), and the metal back layer (5) formed thereon. A second treatment layer containing the aforementioned inorganic oxide can be formed on the metal back layer (5). A metal back-attached phosphor screen, when used in an image display device such as a FED, can not only inhibit the occurrence of abnormal discharge and improve withstand voltage characteristics but also can increase brightness.

### TECHNICAL FIELD

The present invention relates to a metal back-attached phosphor screen applied to an image display device, a method of forming the same, and an image display device including the metal back-attached phosphor screen.

### BACKGROUND ART

Conventionally, in an image display device such as a cathode-ray tube (CRT), a metal back-attached phosphor screen having a metal film such as an aluminum (Al) film on an inner surface (a surface facing an electron source) of a phosphor layer has beenwidely adopted.

The metal film is called a metal back layer and is disposed to increase brightness by reflecting light to a face plate, the light being emitted from a phosphor by electrons released from the electron source and advancing toward the electron source, and to function as an anode electrode by giving conductivity to the phosphor screen. This metal film further has a function of preventing the phosphor from being damaged by ions generated due to ionization of gas remaining in a vacuum envelope.

For many years, a CRT to which such a metal back-attached phosphor screen has been applied is the dominant display device, but in recent years, with an increase in the need for thinning and increasing the size of the device, the development of a field emission display (FED) of non-deflected electron beam type with a cold cathode has been rapidly advanced.

Generally, in the image display device, the larger the potential difference between an anode (metal back side) and a cathode (electron source side), the higher light-emission brightness can be obtained, but there is a problem that abnormal discharge tends to occur between the anode and the cathode because the distance between the electrodes reduces with the thinning of the device. If abnormal discharge occurs, not only stable images cannot be displayed but also a discharge current as large as several amperes to several hundred amperes flows instantaneously, which raises a possibility that an electron emitting element of a cathode part or the phosphor screen of an anode part is destroyed or damaged.

In order to relieve the damage when such abnormal discharge occurs, forming a zigzag (meandering) or spiral gap in the metal back layer used as the anode electrode is proposed to reduce the discharge current. As a method of fabricating or forming such an anode electrode, a method of cutting by a laser or deposition by a metal mask is described (See Japanese Patent Laid-open Application No. 2000-251797 or Japanese Patent laid-open Application No. 2000-311642).

However, the aforementioned method of reducing the discharge current by forming the metal back layer in a plane coil shape is an art to prevent the metal back layer or the electron source from being damaged/destroyed when the abnormal discharge occurs, but this method cannot reduce the probability of occurrence of abnormal discharge itself.

Moreover, a method of decreasing the electron beam accelerating voltage to a range in which no electric discharge occurs has been hitherto adopted as a countermeasure to inhibit the occurrence of abnormal discharge, but in this method, the narrower the gap between electrodes in the image display device, the lower the electron beam accelerating voltage needs to be set, hence in the FED, the light-emission brightness becomes extremely low, and accordingly, in the present situation, this is of no practical use.

The present inventors note that in the thin image display device such as the FED, many fine fragments of the metal back layer adhere to the cathode side due to the occurrence of abnormal discharge even when there is no projecting portion which triggers discharge on the surface of the metal back layer. As a result of investigating the phosphor screen of the image display device in which such discharge occurs, it is found that as shown in FIG. 16, innumerable minute projections 22 are formed on the surface of an Al film which is a metal back layer 21 and these projection 22 portions are about to peel off.

From this, it is thought that force to peel off the metal back layer 21 by an electric field between the anode and the cathode exceeds adhesive force between a phosphor layer 23 and the metal back layer 21, peeling occurs in the form of the minute projections 22 in the metal back layer 21, which, as a discharge trigger, causes the occurrence of abnormal discharge. Incidentally, in this figure, numeral 24 denotes a face plate, and numeral 25 denotes a light absorption layer which is a black matrix.

The present invention has been made in view of these respects and its object is to provide a metal back-attached phosphor screen with excellent withstand voltage characteristics capable of increasing the electron beam accelerating voltage without causing the occurrence of abnormal discharge and being applied to a thin image display device with a high light-emission brightness.

### DISCLOSURE OF THE INVENTION

The present invention is obtained as a result of diligently repeating experiments on the correlation between the adhesive force between a phosphor layer and a metal back layer and the occurrence of electric discharge in a thin image display device such as a FED.

A first aspect of the present invention is a metal back-attached phosphor screen comprising a phosphor layer and a metal back layer on an inner surface of a face plate, in which a first treatment layer containing an oxide of one kind or two or more kinds of elements selected from the group consisting of silicon, aluminum, titanium, and zirconium is formed on the phosphor layer and the metal back layer is formed on the first treatment layer.

A second aspect of the present invention is a metal back-attached phosphor screen comprising a phosphor layer and a metal back layer on an inner surface of a face plate, in which a first treatment layer containing one kind or two or more kinds of inorganic oxides selected from the group consisting of silicon oxide, a silicon oxide containing one kind or two or more kinds of alkali metal elements, aluminum oxide, titanium oxide, and zirconium oxide is formed on the phosphor layer and the metal back layer is formed on the first treatment layer.

A third aspect of the present invention is a method of forming a metal back-attached phosphor screen which comprises forming a phosphor layer on an inner surface of a face plate, forming a first treatment layer containing an oxide of one kind or two or more kinds of elements selected from the group consisting of silicon, aluminum, titanium, and zirconium on the phosphor layer, and forming a metal back layer on the first treatment layer.

A fourth aspect of the present invention is a method of forming a metal back-attached phosphor screen which comprises forming a phosphor layer on an inner surface of a face plate, forming a first treatment layer containing one kind or two or more kinds of inorganic oxides selected from the group consisting of silicon oxide, a silicon oxide containing one kind or two or more kinds of alkali metal elements, aluminum oxide, titanium oxide, and zirconium oxide on the phosphor layer, and forming a metal back layer on the first treatment layer.

A fifth aspect of the present invention is an image display device which comprises a face plate, a rear plate disposed facing the face plate, numerous electron emitting elements formed on the rear plate, and a phosphor screen formed on the face plate in such a way as to face the rear plate and emitting light by electron beams emitted from the electron emitting elements, the phosphor screen being the aforementioned metal back-attached phosphor screen in the present invention.

### BRIEF DESCRIPTION OF DRAWINGS

FIG. 1 is a sectional view showing a first embodiment of a metal back-attached phosphor screen according to the present invention.

FIG. 2 is a sectional view showing a second embodiment of the metal back-attached phosphor screen according to the present invention.

FIG. 3 is a sectional view showing the structure of a FED which is a fourth embodiment of the present invention.

FIG. 4 is a graph showing results of measuring and evaluating the relation between the solid content concentration of a colloidal silica solution and the adhesive force of a metal back layer in Examples 1 and 2.

FIG. 5 is a graph showing results of measuring and evaluating the relation between the solid content concentration of a Na silicate solution and the adhesive force of the metal back layer in Examples 1 and 2.

FIG. 6 is a graph showing results of measuring and evaluating the relation between the solid content concentration of the colloidal silica solution and critical holding voltage in Examples 1 and 2.

FIG. 7 is a graph showing results of measuring and evaluating the relation between the solid content concentration of the Na silicate solution and the critical holding voltage in Examples 1 and 2.

FIG. 8 is a graph showing results of measuring and evaluating the relation between the solid content concentration of the colloidal silica solution and the critical holding voltage when an Al film is previously flawed in Example 3.

FIG. 9 is a graph showing results of measuring and evaluating the solid content concentration of the Na silicate solution and the critical holding voltage when the Al film is previously flawed in Example 3.

FIG. 10 is a graph showing results of measuring the relation between the thickness of the Al film which is the metal back layer and light-emission brightness.

FIG. 11 is a graph showing results of examining the relation between compounded percentages of SiO₂ and TiO₂ and adhesive force regarding metal back-attached phosphor screen samples in Example 4.

FIG. 12 is a view showing the schematic structure of a brightness measuring device used in Example 4.

FIG. 13 is a graph showing results of examining the relation between compounded percentages of SiO₂ and TiO₂ and brightness reduction rate at an anode voltage of 5 kV regarding the metal back-attached phosphor screen samples in Example 4.

FIG. 14 is a graph showing a region capable of increasing the adhesive force and the critical holding voltage while maintaining brightness characteristics in a composite metal oxide film containing three components of Si, Ti, and Zr in Example 4.

FIG. 15 is a graph showing results of measuring the relation between the adhesive force of the metal back layer and bright reduction in Example 5.

FIG. 16 is a sectional view showing the state of a phosphor screen of an image display device in which discharge occurs.

### BEST MODE FOR CARRYING OUT THE INVENTION

Preferred embodiments of the present invention will be described below. It should be noted that the present invention is not limited to the following embodiments.

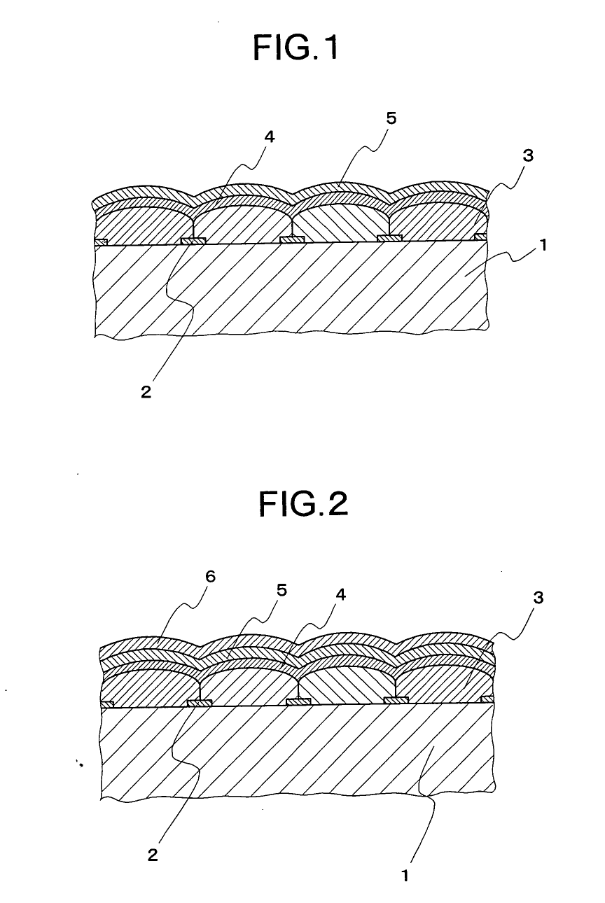

FIG. 1 is a sectional view showing a first embodiment of a metal back-attached phosphor screen of the present invention.

In FIG. 1, numeral 1 denotes a glass substrate of a face plate. A light absorption layer 2 in a predetermined pattern (for example, in a striped pattern) composed of a black pigment or the like is formed on an inner surface of the glass substrate 1 by photolithography or the like, and a phosphor layer 3 of three colors of blue (B), green (G), and red (R) is formed on the pattern of the light absorption layer 2 by a slurry method using ZnS-based, Y₂O₃-based, and Y₂O₂S-based phosphor liquids or the like. The phosphor layer 3 of individual colors can also be formed by a spray method or a printing method. When the spray method or the printing method is used, patterning by photolithography can be used together, if necessary. The phosphor screen having the pattern of the light absorption layer 2 and the three-color pattern of the phosphor layer 3 is formed, as described above.

A first treatment layer 4 containing an inorganic oxide is formed on this phosphor screen. Here, as the inorganic oxide, silicon dioxide (SiO₂), a silicon oxide containing an alkali metal such as Na, K, or Li, aluminum oxide (Al₂O₃), titanium oxide (TiO₂), zirconium oxide (ZrO₂), or the like is used.

To form these layers, for example, a method of applying/drying a colloidal silica solution or a Na silicate (sodium silicate) solution and heat-treating (baking) a resulting coating film can be adopted. By applying/drying and heat-treating (baking) the colloidal silica solution, a silica (SiO₂) particle layer is formed. In the method of applying/drying and heat-treating the Na silicate solution, an alkali silicate glass (Na₂O.nSiO₂) layer is formed.

Moreover, with alkoxide (alcoholate) containing of at least one kind of element selected from Si, Ti and zr as a starting material, a film containing at least one kind of oxide selected from SiO₂, TiO₂, and ZrO₂ can be formed by a sol-gel method. For example, by applying/drying a liquid containing oligomer which is obtained by hydrolyzing and polycondensing alkoxide such as ethyl silicate or methyl silicate in a solution containing an organic solvent, and heat-treating (baking) a coating film, a SiO₂ film can be formed.

Further, by forming the first treatment layer containing a composite oxide of at least two kinds selected from Si, Ti, and Zr, reduction in light-emission brightness can be inhibited, and the adhesive force of the metal back layer can be improved to the maximum extent possible. It is desirable that all the following expressions hold when content percentages of respective components in the first treatment layer are expressed as weight percentages, the respective components are turned into oxides (SiO₂, TiO₂, and ZrO₂), and silicon dioxide, titanium oxide, and zirconium oxide are x1%, y1%, and z1%, respectively.
70≦x1+y1<100
x1+0.5y1≦80
x1+y1+z1=100
(where x1>0, y1>0, z1>0)

Furthermore, in the first embodiment, a metal back layer 5 made of a metal film such as an Al film is formed on the first treatment layer 4 containing the aforementioned inorganic oxide. To form the metal back layer 5, the metal film of Al or the like can be vacuum-deposited on a thin film made of an organic resin such as nitrocellulose, for example, formed by a spin method, then be heat-treated (baked) at a temperature approximately between 400° C. and 450° C., and an organic material can be decomposed/removed.

In the first embodiment, the first treatment layer 4 containing the inorganic oxide such as silicon dioxide (SiO₂), a silicon oxide containing analkali metal such as Na, K, or Li, aluminum oxide (Al₂O₃), titanium oxide (TiO₂), or zirconium oxide (ZrO₂) is disposed on the phosphor layer 3, and the metal back layer 5 is formed on the first treatment layer 4, whereby adhesive strength between the metal back layer 5 and a layer thereunder is large, and the metal layer 5 is resistant to peeling even when an electric field is applied. Accordingly, the probability of occurrence of abnormal discharge is low, resulting in excellent withstand voltage characteristics.

Next, a second embodiment of the present invention will be described.

As shown in FIG. 2, in a metal back-attached phosphor screen in the second embodiment, a second treatment layer 6 is formed on the metal back layer 5. Incidentally, the structures of the other portions are the same as those in the first embodiment, and hence an explanation thereof is omitted.

As a material composing the second treatment layer 6, an inorganic oxide of the same kind as the first treatment layer 4 can be used. The second treatment layer 6 can be formed in the same manner as informing the first treatment layer 4. Moreover, informing the second treatment layer 6, it is also possible to use an Si target and thermal spray/form a SiOₓ layer by a sputtering method while introducing oxygen into a vacuum vessel.

In the second embodiment, the first treatment layer 4 containing the inorganic oxide such as silicon dioxide (SiO₂), titanium oxide (TiO₂), or zirconium oxide (ZrO₂) is formed on the phosphor layer 3, and besides the second treatment layer 6 containing the aforementioned inorganic oxide is also formed on the metal back layer 5, whereby the adhesive strength of the metal back layer 5 is further improved. Accordingly, the metal back layer 5 becomes more resistant to peeling, which prevents the occurrence of abnormal discharge.

As just described, by both forming the first treatment layer 4 on the phosphor layer 3 and forming the second treatment layer 6 on the metal back layer 5 for optimization, the adhesive force of the metal back layer 5 is increased, which can efficiently improve withstand voltage characteristics.

Moreover, as a third embodiment of the present invention, the first treatment layer can be formed through a two-step coating film formation process as shown below.

After a lower coating film which becomes a barrier against an organic solvent is formed on the phosphor layer by applying/drying a coating solution which contains water such as a colloidal silica solution or a Na silicate solution, an upper coating film can be formed on the lower coating film by applying/drying a coating solution which contains an organic solvent such as a mixed solution containing oligomer which is obtained by hydrolyzing and polycondensing alkoxide such as Si alkoxide. Thereafter, by heat-treating (baking) the entire coating film in which the lower coating film and the upper coating film are stacked, the treatment layer made of the inorganic oxide is formed. This makes it possible to inhibit deterioration of a phosphor due to adhesion of the organic solvent and prevent reduction in brightness.

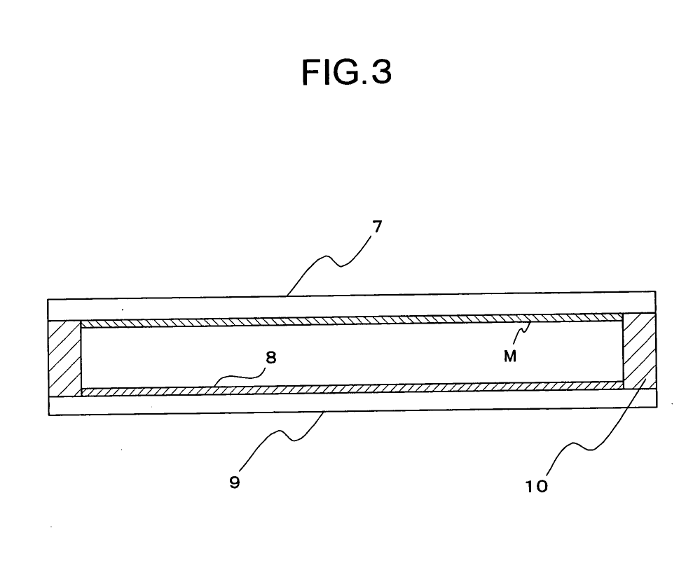

Next, as a fourth embodiment of the present invention, a FED including the metal-baked phosphor screen as an anode electrode is shown in FIG. 3.

In this FED, a face plate 7 having a metal back-attached phosphor screen M in the aforementioned first embodiment and a rear plate 9 having electron emitting elements 8 arranged in a matrix are placed facing to each other with a space as narrow as approximately from one millimeter to several millimeters, and a high voltage from 5 kV to 15 kV is applied between the face plate 7 and the rear plate 9. Numeral 10 in this figure denotes a supporting frame (sidewall).

The space between the face plate 7 and the rear plate 9 is extremely narrow and discharge (dielectric breakdown) tends to occur between these plates, but in the FED, the metal back layer is resistant to peeling since its adhesive strength is large, whereby the probability of production of projecting portions which trigger discharge is low. Hence, the occurrence of discharge is inhibited, and thereby withstand voltage characteristics are greatly improved.

In the metal back-attached phosphor screen of the present invention, the first treatment layer containing one kind or two or more kinds of inorganic oxides selected from silicon oxide, a silicon oxide containing one kind or two or more kinds of alkali metal elements, aluminum oxide, titanium oxide, and zirconium oxide is formed on the phosphor layer, and the metal back layer is formed on the first treatment layer, whereby the adhesion strength between the layer containing the aforementioned inorganic oxide and the metal back layer is large, and therefore the metal back layer is resistant to peeling caused by the application of voltage. Accordingly, excellent withstand voltage characteristics are attained, and the probability of occurrence of abnormal discharge is low. Moreover, the electron beam accelerating voltage can be increased, and hence an image display device with high light-emission brightness can be obtained.

Next, specific examples of the present invention will be described. In the following examples, every % shows wt%.

### EXAMPLE 1

A coating film was formed on the phosphor layer by coating a solution of colloidal silica whose solid content concentration was adjusted and a solution of Na silicate whose solid content concentration was also adjusted, and the correlation between adhesive force between the phosphor layer and the metal-back layer and discharge occurrence was examined. The procedure for fabricating samples is shown below.

First, blue phosphor layers were formed on soda glass substrates (10 cm long×10 cm wide) by the slurry method.

Then, colloidal silica solutions whose solid content concentrations were adjusted to 2%, 5%, 10%, and 20%, respectively by dilution with pure water, and Na silicate (water glass) solutions whose concentrations were adjusted similarly were applied onto the aforementioned phosphor layers by the spray method to form coating films. Additionally, a sample in which the coating film was not formed on the phosphor layer was prepared.

Subsequently, after an organic film was formed on each of the coating films by a well-known lacquer method, Al was deposited on this organic film, and an Al film 100 nm in thickness was formed. Thereafter, organic components were decomposed/removed by baking at 430° C. for 30 minutes. Thus, the first treatment layer composed of the inorganic oxide was formed on the phosphor layer.

Incidentally, the coating film formed of the colloidal silica solution finally becomes a layer including silica (SiO₂) particles by baking. Similarly, the coating film formed of the Na silicate solution becomes a layer including alkali silicate glass (Na₂O.nSiO₂) particles.

Thereafter, in the thus fabricated metal back-attached phosphor screen samples, the adhesive force of the metal back layers was evaluated in the way shown below. First, three kinds of adhesive sheets different in adhesion were fabricated by applying/drying toluene solutions of vinyl acetate (solid content concentrations 1%, 2%, and 4%) on a polyethylene film 20 μm in thickness using a bar coater.

These adhesive sheets were cut into 1 cm by 1 cm squares, and an adhesive surface was placed so as to touch the surface of the metal back layer (Al film) of each of the samples. Then, after being pressed by a load of 3 kgf with a rubber roller, the adhesive sheet was stripped off. Subsequently, the degree of adhesion of the Al film to the adhesive surface of the stripped adhesive sheet was examined and marked. With a case where no Al film adhered to the adhesive surface as 4 points, a case where a small amount of Al film which was peeled into small fragments adhered to the adhesive surface as 3 points, a case where approximately a half of the Al film peeled from the sample and adheres to the adhesive surface as 2 points, a case where most of the Al film peels off as 1 point, and a case where all of the Al film peeled off as 0 points, the evaluation was performed by a total score (perfect score: 12 points) of three kinds of adhesive sheets different in adhesion.

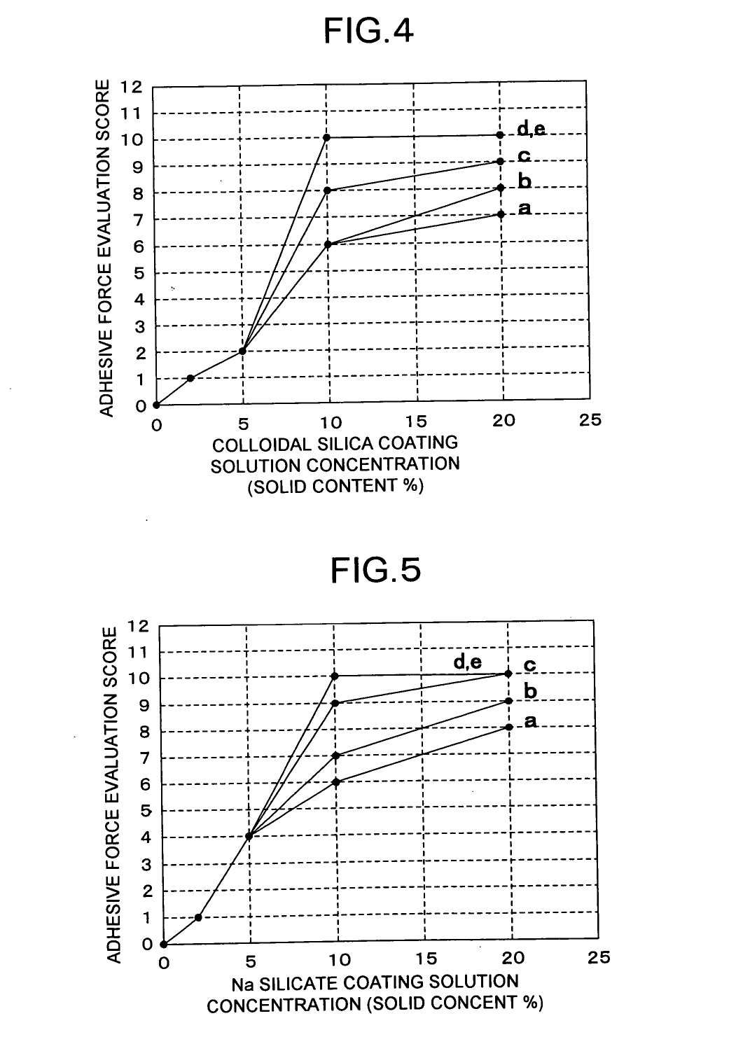

Evaluation results of the adhesive force of the metal back layers by the aforementioned method are shown by curves a in FIG. 4 and FIG. 5, respectively. Incidentally, FIG. 4 shows the relation between the solid content concentration of the colloidal silica solution and the adhesive force evaluation score, and FIG. 5 shows the relation between the solid content concentration of the Na silicate (water glass) solution and the adhesive force evaluation score.

From FIG. 4 and FIG. 5, it is known that in either case of the application of the colloidal silica solution and the Na silicate solution, the adhesive force between the first treatment layer and the metal back layer increases as the solid content concentration of the coating solution becomes higher. However, when the solid content concentration becomes equal to or higher than a certain value, the effect of increasing the adhesive force produced by the increase of concentration becomes saturated.

Then, as concerns the same samples, withstand voltage characteristics were evaluated in the way shown below. Namely, the metal back-attached phosphor screen sample fabricated by the aforementioned method and a substrate obtained by forming an ITO film on a soda glass plate by deposition were placed in such a way that a surface on which ITO was deposited faced the metal-baked phosphor screen and a gap therebetween was maintained at 2 mm. Subsequently, a pseudo electron beam accelerator was fabricated by connecting the metal back-attached phosphor screen as an anode and the ITO film as a cathode to a direct current power supply in an atmosphere which was a vacuum of approximately 1×10⁻⁵ Pa.

Thereafter, in such an electron beam accelerator, potential difference was provided between the electrodes at a speed of 0.1 kV/sec and a voltage Va at which electric discharge occurs was measured. After several tens of Va were measured with respect to one kind of phosphor screen, a voltage (Va −3σ) which was obtained by subtracting three times a standard deviation σ from a mean value of Va was defined as a critical holding voltage of the sample.

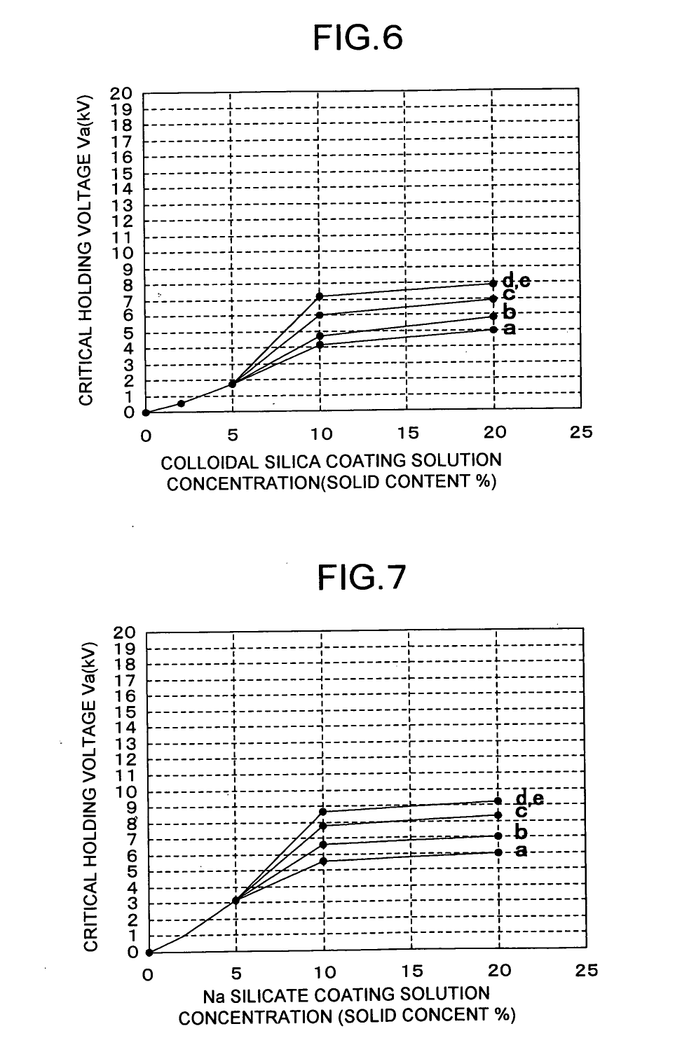

Evaluation results of the withstand voltage characteristics of the samples by the aforementioned method is shown by curves a in FIG. 6 and FIG. 7 respectively. Incidentally, FIG. 6 shows the relation between the solid content concentration of the colloidal silica solution and the critical holding voltage, and FIG. 7 shows the relation between the solid content concentration of the Na silicate solution and the critical holding voltage.

From FIG. 6 and FIG. 7, it is known that in either case of the application of the colloidal silica solution and the Na silicate solution, the critical holding voltage of the sample increases as the solid content concentration of the coating solution becomes higher. However, when the solid content concentration becomes equal to or higher than a certain value, the effect of increasing the critical holding voltage produced by the increase of concentration becomes saturated.

Moreover, from FIG. 4 to FIG. 7, it is confirmed that as the adhesive force of the metal back layer increases, the critical holding voltage becomes higher and the probability of occurrence of abnormal discharge reduces.

### EXAMPLE 2

The relation between the formation of the coating film on the metal back layer and the adhesive force of the metal back layer and the withstand voltage characteristics was examined in the way shown below.

Colloidal silica solutions whose solid content concentrations were adjusted to 2%, 5%, 10%, and 20%, respectively, by dilution with pure water, and Na silicate solutions whose concentrations were adjusted similarly were applied onto the metal back layers (Al films) of the respective samples fabricated in Example 1 by the spray method to form coating films. Thereafter, the second treatment layer composed of the inorganic oxide was formed on each of the metal back layers by baking at 430° C. for 30 minutes.

Then, the adhesive force and voltage withstand characteristics of each of the samples thus fabricated were measured/evaluated in the same way as in Example 1. Evaluation results of the adhesive force are shown by curves b to e in FIG. 4 and curves b to e in FIG. 5. Measurement results of the critical holding voltage are shown by curves b to e in FIG. 6 and curves b to e in FIG. 7.

Incidentally, the curve b in FIG. 4 and the curve b in FIG. 6 show measurement results when the first treatment layer is formed on the phosphor layer by using the colloidal silica solution and the second treatment layer is formed on the Al film by using the colloidal silica solution whose solid content concentration is 2%, and similarly the curves c, the curves d, and the curves e in FIG. 4 and FIG. 6 respectively show measurement results when the coating solution on the phosphor layer is the colloidal silica solution and the coating solutions on the Al film are 5%, 10%, and 20% colloidal silica solutions.

Further, the curve b in FIG. 5 and the curve b in FIG. 7 show measurement results when the first treatment layer is formed on the phosphor layer by using the Na silicate solution and the second treatment layer is formed on the Al film by using the Na silicate solution whose solid content concentration is 2%, and similarly the curves c, the curves d, and the curves e in FIG. 5 and FIG. 7 respectively show measurement results when the coating solution on the phosphor layer is the Na silicate solution and the coating solutions on the Al film are 5%, 10%, and 20% Na silicate solutions.

From respective graphs in FIG. 4 to FIG. 7, it is known that the effect of increasing the adhesive force of the metal back layer and improving the withstand voltage characteristics cannot be obtained by only forming the second treatment layer on the Al film without forming the first treatment layer on the phosphor layer. It is further known that when the first treatment layer is formed on the phosphor layer and the second treatment layer is formed on the Al film, the adhesive force of the metal back layer is further increased and the withstand voltage characteristics are further improved by a synergistic effect between the first treatment layer and the second treatment layer. It is furthermore known that as the solid content concentration of the solution (colloidal silica solution or Na silicate solution) applied onto the phosphor layer becomes higher, the synergistic effect of increasing the adhesive force increases.

### EXAMPLE 3

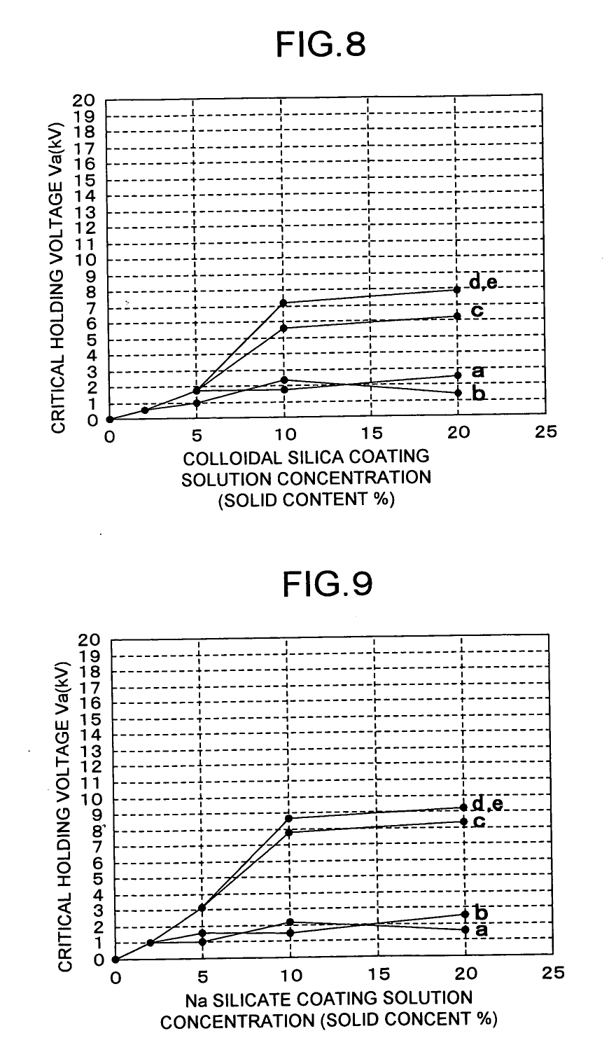

It is thought that the reason why the formation of the second treatment layer on the Al film produces an effect is that this treatment layer mends minute defects such as pinholes existing in the Al film. To verify this, using the Al film which was previously flawed, the same examination as in Example 2 was made, and the withstand voltage characteristics (critical holding voltages) were measured/evaluated. Measurement results are shown by curves a to e in FIG. 8 and curves a to e in FIG. 9, respectively.

The curve a in FIG. 8 shows a measurement result when the solution applied onto the phosphor layer is the colloidal silica solution and no coating treatment is performed on the Al film, and the curve b, the curve c, the curve d, and the curve e in FIG. 8 show measurement results when the coating solution on the phosphor layer is the colloidal silica solution and the solutions applied onto the Al film are colloidal silica solutions whose solid content concentrations are 2%, 5%, 10%, and 20%, respectively.

Moreover, the curve a in FIG. 9 shows a measurement result when the solution applied onto the phosphor layer is the Na silicate solution and no coating treatment is performed on the Al film, and the curve b, the curve c, the curve d, and the curve e in FIG. 9 show measurement results when the coating solution on the phosphor layer is the Na silicate solution and the solutions applied onto the Al film are Na silicate solutions whose solid content concentrations are 2%, 5%, 10%, and 20%, respectively.

By comparing FIG. 8 and FIG. 6 and comparing FIG. 9 and FIG. 7, it is known that when the Al film is flawed, the effect of improving the withstand voltage characteristics produced by the formation of the first treatment layer on the phosphor layer reduces. However, by forming the first treatment layer on the phosphor layer and further forming the second treatment layer on the Al film layer, the effect of improving the withstand voltage characteristics gets better to the same level as that without any flaw.

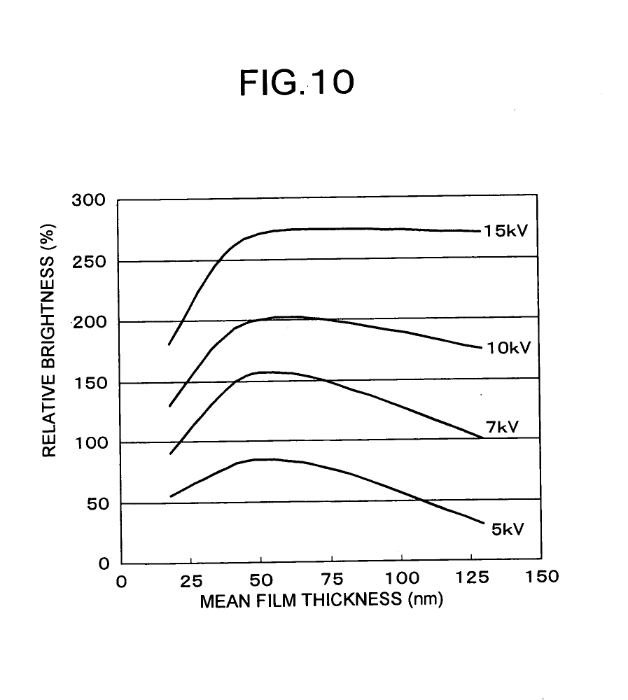

Then, to examine a lower limit value of the critical holding voltage in the metal back-attached phosphor screen, the driving voltage (anode voltage) was changed in a range from 5 kV to 15 kV, and the relation between the film thickness of the Al film (the metal back layer) and light-emission brightness (relative brightness) was measured. Measurement results are shown in FIG. 10.

Respective curves in FIG. 10 show measurement results when the anode voltage is 5 kV, 7 kV, 10 kV, and 15 kV. The lower the driving voltage, the sharper peak appears in the light-emission brightness, and the peak value appears when the thickness of the Al film is approximately 50 nm. When the driving voltage is less than 3 kv in approximately 50 nm of the Al film thickness, the electron beam does not easily pass through the metal back layer, and therefore the phosphor hardly emits light. Accordingly, it turns out that the metal back-attached phosphor screen cannot be used as a phosphor screen unless the critical holding voltage is equal to or higher than 3 kV.

The solid content concentration of the colloidal silica solution or the Na silicate solution as the coating solution and the content of the inorganic oxide in the first or the second treatment layer formed from this coating solution are in proportion. Hence, an optimum range of the content of the inorganic oxide in the first or the second treatment layer can be found from an optimum range of the aforementioned solid content concentration of the coating solution.

First, an adhesive tape was stuck on an Al film side of the sample by pressing it with a finger. Then, the adhesive tape was stripped off and separated into a layer lower than the Al film (decomposition sample-1) and a layer including and upper than the Al film (decomposition sample-2). Subsequently, both the samples were decomposed by an acid and subjected to elemental analysis by an ICP-AES method.

As concerns the decomposition sample-1, the weight per unit area of the phosphor was found by the following method. First, after the weight of Zn which was a basic component of the used blue phosphor was found, the weight was converted into ZnS to obtain the weight of the phosphor. Then, after the weight of the Si being a component of the first treatment layer was found, the weight was converted into SiO₂ to obtain the weight of the first treatment layer.

Thus, it was known that when the content (per unit area, hereinafter same as this) of the inorganic oxide in the first treatment layer was 2% to 20% of the content per unit area of the phosphor in the phosphor layer, the metal back-attached phosphor screen having a critical holding voltage equal to or higher than 3 kV could be obtained and used as a phosphor screen of a thin display device.

Then, as a result of finding the weight of SiO₂ in the decomposition sample-2 using the same method also when the treatment layer (second treatment layer) was further formed on the Al film, it was known that by converting the content of the inorganic oxide in the second treatment layer into the component weight per unit area of the metal back layer on the phosphor layer to obtain 4 μg/cm² to 40 μg/cm², the critical holding voltage could be further increased. When the inorganic oxide in the second treatment layer exceeds 4 μg/cm² to 40 μg/cm², the effect of increasing the critical holding voltage was saturated and no longer improved.

### EXAMPLE 4

A mixed solution containing oligomer which was obtained by hydrolyzing and polycondensing various kinds of alkoxides was prepared in the way shown below. At least one kind selected from tetraethyl silicate (tetraethoxysilane), tetraethyl titanate (tetraethoxytitanium), and zirconium tetra-n-butoxide was used as the alkoxide, and the hydrolysis was performed stepwise according to the number of used alkoxides to prepare the coating solution in which oligomer was mixed.

After proper quantities of ethanol, nitric acid, and pure water were added to a first alkokide and stirred for several tens of minutes, proper quantities of a second alkoxide and pure water were added thereto and stirred for several tens of minutes. When a third alkoxide was used, proper quantities of the third alkoxide and pure water were added and stirred for several tens of minutes. Then, after the temperature of the solution was increased to 50° C. and the solution was stirred for a proper period of time, a proper quantity of pure water was added, and then the solution was stirred at 50° C. for a proper period of time. Subsequently, after the temperature of the solution was decreased to around room temperature, IPA (isopropyl alcohol) was added to dilute the solution to three times to five times its original concentration to prevent gelation to thereby obtain the coating solution. Incidentally, conditions such as component materials other than the alkoxide, stirring time, and dilution concentration were adjusted properly according to the compounded quantity of alkoxide.

The mixed solution containing two or more kinds of oligomers prepared through the aforementioned procedure was used in place of the colloidal silica solution and the Na silicate solution to form the coating film on the phosphor layer by the spray method. Then, after an organic film was formed on the coating film by the well-known lacquer method, Al was deposited on the organic film by a deposition method to form an Al film 100 nm in thickness, and thereafter, organic components were decomposed/removed by baking at 430° C. for 30 minutes. Moreover, after a coating film was also formed on the Al film thus formed using the aforementioned mixed solution, the coating film was baked.

Thus, composite oxide layers containing a SiO₂ component, a TiO₂ component, and a ZrO₂ component in various percentages (weight ratios) were formed on the phosphor layer and the Al film. Incidentally, when the mixed solution was applied, the solid content concentration and the coating thickness of the mixed solution were adjusted in such a way that the content per unit area of all the inorganic oxides finally formed by heat treatment was 10% of the content of the phosphor of the lower layer.

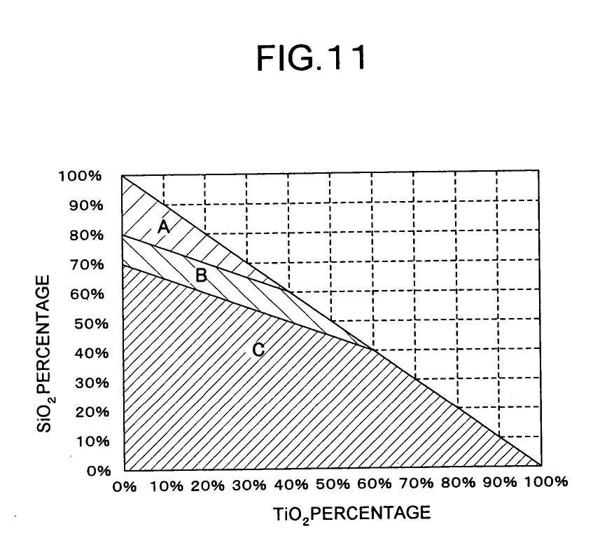

As concerns the metal back-attached phosphor screen samples obtained by adjustment in various compounding ratios, the relation between the compounded quantity and adhesive force was examined. Results are shown in FIG. 11. FIG. 11 shows the adhesive force with respect to the percentages of SiO₂ and TiO₂, and the remaining percentage is the percentage of ZrO₂. In this figure, a region A shows a region where the adhesive force scores less than 8 points and is the same as that when colloidal silica, Na silicate, or the like is used singly, a region B shows a region where the adhesive force scores 8 points to 10 points and is slightly improved, and a region C shows a region where the adhesive force gets full 12 points, respectively.

As shown in FIG. 11, as the percentages of TiO₂ and ZrO₂ increase, the adhesive force improves. If approximate numerical expressions are formulated, it is said that the adhesive force further improves in a region where all the following expressions hold when SiO₂ is x%, TiO₂ is y %, and ZrO₂ is z %.
x+y<100
x+0.5y≦80
x+y+z=100
(where x>0, y>0, z>0)

Next, when the critical holding voltage was examined in the same manner, the relation which was almost proportional to the aforementioned relation regarding the adhesive force was obtained. The critical holding voltage in the region A was less than 6 kV, the critical holding voltage in the region B was 6 kV to 9 kV, and the critical holding voltage in the region C was 9 kV to 12 kV.

Moreover, since Zr which was a component of ZrO₂ has a large atomic number and hence since there was a possibility of a reduction in the transmittance of an electron beam, the brightness reduction rate was examined regarding the aforementioned samples.

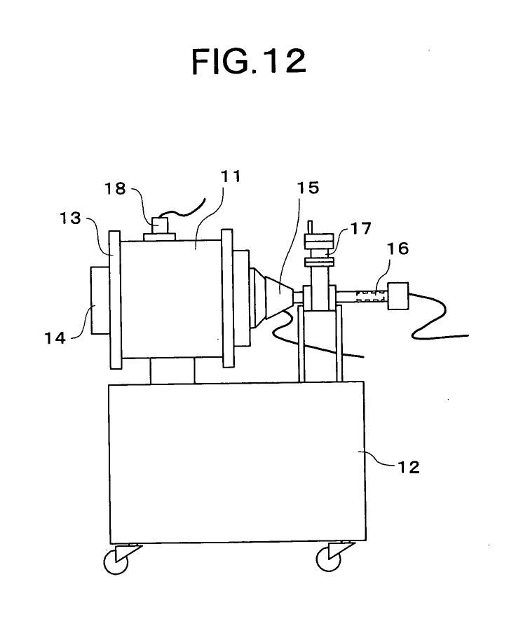

Measurements were made in the way shown below. The schematic structure of a brightness measuring device is shown in FIG. 12. In this figure, numeral 11 denotes a vacuum chamber which is also used as an earth to house the sample, numeral 12 denotes a vacuum pump, numeral 13 denotes a lid to take out the sample, numeral 14 denotes a brightness measuring glass window, numeral 15 denotes a deflection yoke, numeral 16 denotes an electron gun for the CRT, numeral 17 denotes an electron gun atmosphere interrupting unit, and numeral 18 denotes an anode supply terminal, respectively.

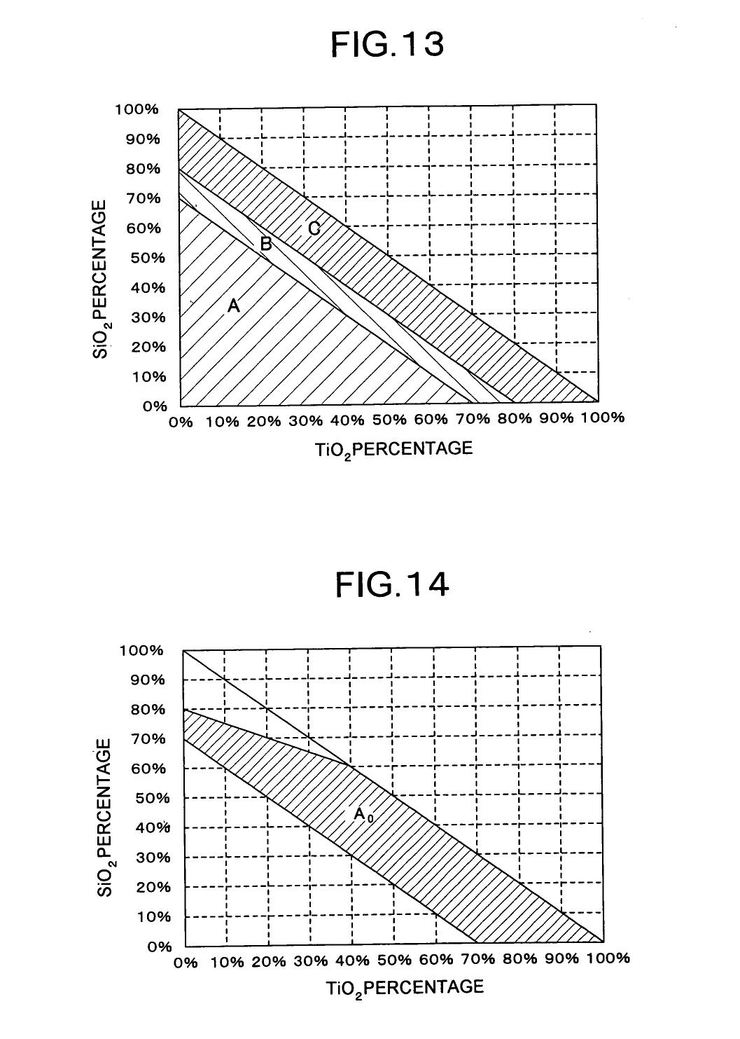

First, the sample was placed in the vacuum chamber with its metal back layer facing toward the electron gun side, and the metal back layer and an anode terminal were connected. The space between the electron gun and the sample was set to 30 cm in order to prevent discharge caused by the deposition of the metal back layer. The interior of the vacuum chamber was maintained at a vacuum of approximately 1×10⁻⁵ Pa, the electron gun and the deflection yoke were driven at a desired anode voltage, and the brightness was measured from the brightness measuring glass window. Measurement results are shown in FIG. 13.

FIG. 13 shows the distribution of brightness reduction rate with respect to the percentages of SiO₂ and TiO₂ (at an anode voltage of 5 kV), and the remaining percentage is the percentage of ZrO₂. In this figure, a region A shows a region of no practical use where the brightness reduction rate is equal to or more than 30%, a region B is a practical-level region where the brightness reduction rate is equal to or more than 10% and less than 30%, and a region C is a region where the brightness reduction rate is less than 10% and the brightness is specially satisfactory, respectively.

As shown in FIG. 13, as the percentage of ZrO₂ increases, the brightness reduction rate increases. When approximate numerical expressions are formulated, the practical-level brightness characteristics can be maintained in a region where all the following expressions hold when SiO₂ is x %, TiO₂ is y%, and ZrO₂ is z %.
70≦x+y<100
x+y+z=100
(where x>0, y>0, z>0)

When the aforementioned results are summarized, the compounding ratio needs to be determined in a combined region of the aforementioned respective regions in order to efficiently utilize the property of high adhesive force of a composite metal oxide film containing three components of Si, Ti, and Zr in a practical-level region of brightness. This is shown by a region A₀ in FIG. 14. When approximate numerical expressions are formulated, the adhesive force and the critical holding voltage can be increased while the practical-level brightness characteristics are maintained in a region where all the following expressions hold when SiO₂ is X%, TiO₂ is y %, and ZrO₂ is z %.
70≦x+y<100
x+0.5y≦80
x+y+z=100
(where x>0, y>0, z>0)

Further, when the formation of the second treatment layer on the metal back layer and examinations were made in the aforementioned composition range, it was found that the same tendency as when colloidal silica was used was observed and also there was a synergistic effect. In the aforementioned combined region, the critical holding voltage reached 20 kV at the maximumin some samples.

Furthermore, also when an oxide in which the SiO₂ component and the TiO₂ component were bonded in a matrix in a predetermined ratio (hereinafter referred to as a SiO₂.TiO₂ compounded type oxide) which was obtained by hydrolyzing and polycondensing (copolymerizing) silicon alkoxide and titanium alkoxide by the sol-gel method was provided on the phosphor layer, adhesive force and withstand voltage characteristic were improved. Besides, when the SiO₂.ZrO₂ compounded type oxide was provided on the phosphor layer, the adhesive force of the metal back layer and the withstand voltage characteristics were still further improved.

When an oxide obtained by compounding two or more kinds of components was provided, the effect of improving the adhesive force and the withstand voltage characteristics increased further as the content percentage of the ZrO₂ component was higher.

Moreover, as concerns the treatment of the Al film, the same effect as that when treatment was performed using the colloidal silica solution and the Na silicate solution could be obtained. It was known that when treatment was performed on the phosphor layer by the mixed solution and the treatment was also performed on the Al film, the adhesive force of the metal back layer further increased by the synergistic effect thereof, and the withstand voltage characteristics improved.

### EXAMPLE 5

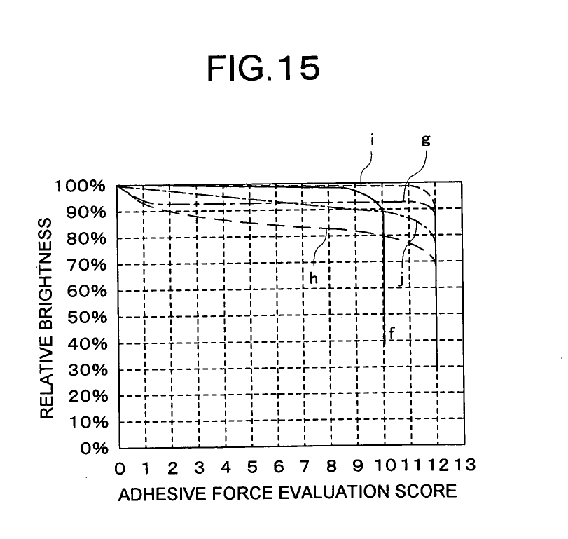

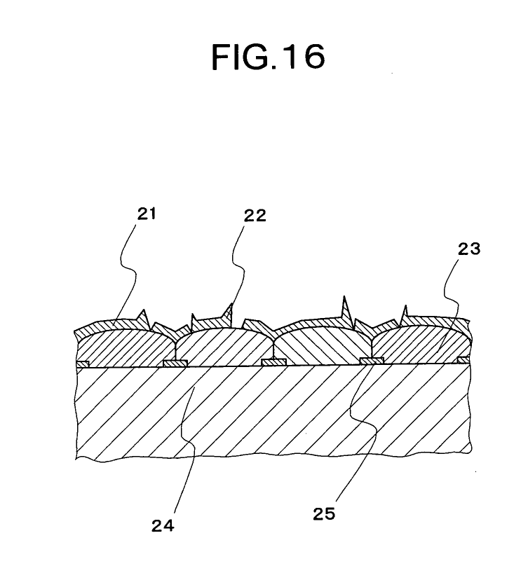

It is predicted that due to the formation of the inorganic oxide layers on the phosphor layer and the Al film, the transmittance of the electron beam reduces and brightness characteristics degrade. Therefore, regarding the metal back-attached phosphor screen samples fabricated in Examples 1 and 2, and Example 4 respectively, the light-emission brightness at an anode voltage of 5 kV was measured by the same method as above. FIG. 15 is a graph showing the relation between the adhesive force of the metal back layer and the brightness reduction obtained as a result of measurement.

A curve f in this figure shows brightness degradation when the colloidal silica solution or the Na silica solution is applied. In any combination, almost the same result can be obtained. It is known that the brightness degradation hardly occurs until the adhesive force saturation concentration is reached, and there is practically no problem if coating is performed at a saturation point of adhesive force.

In this figure, a curve g shows brightness degradation when the solution in the ratio of 20% SiO₂, 70% TiO₂ and 10% ZrO₂ is applied, and a curve h shows brightness degradation when the solution in the ratio of 15% SiO₂, 60% TiO₂ and 25% ZrO₂ is applied.

By changing the concentration, the adhesive force changes, but when the change of the curve g is observed, it can be seen that the brightness degradation does not depend on the adhesive force, and the brightness degrades evenly by approximately 7%. Hence, on the assumption that the phosphor layer was dissolved in a solvent of a sol-gel solution and was deformed, the following examination was made.

First, after the Na silicate solution being a water solvent was applied/dried, the solution in the ratio of 20% SiO₂, 70% TiO₂ and 10% ZrO₂ and the solution in the ratio of 15% SiO₂, 60% TiO₂ and 25% ZrO₂ were prepared while their concentrations were varied and the solutions with various adhesive forces were applied. When the brightness was evaluated again, it was found that the brightness when the solution in the ratio of 20% SiO₂, 70% TiO₂ and 10% ZrO₂ was applied was as shown by a curvei. The brightness when the solution in the ratio of 15% SiO₂, 60% TiO₂ and 25% ZrO₂ was applied was as shown by a curve j, and hence in each case, brightness degradation was inhibited.

As shown in this figure, in the sample in which the layer composed of the inorganic oxide is formed both on the phosphor layer and on the Al film by the application of the colloidal silica solution or the Na silicate solution, the degree of reduction in light-emission brightness with respect to the degree of increase in the adhesive force of the metal-back layer is high. In contrast, in the sample having the layer of the inorganic oxide obtained from the mixed solution containing oligomer obtained by hydrolyzing and polymerizing alkoxide, the degree of reduction in brightness with respect to the degree of increase in adhesive force is low.

In the sample having the layer of the inorganic oxide containing the TiO₂ component, the reduction in light-emission brightness is small, and particularly the sample in which the SiO₂ TiO₂ compounded type oxide layer is formed has excellent brightness characteristics. Moreover, in the sample having the SiO₂ ZrO₂ compounded type oxide layer, the adhesive force of the metal back layer is greatly improved.

### INDUSTRIAL APPLICABILITY

As described above, according to the present invention, a phosphor screen whose metal back layer has a high adhesive strength and is resistant to peeling caused by voltage application can be obtained. Accordingly, the electron beam accelerating voltage can be increased because of excellent withstand voltage characteristics and a low probability of occurrence of abnormal discharge, and a high-voltage drive and high light-emission brightness thin display device can be realized.

What is claimed is:

1. A metal back-attached phosphor screen, comprising a phosphor layer and a metal back layer on an inner surface of a face plate, wherein a first treatment layer containing an oxide of one kind or two or more kinds of elements selected from the group consisting of silicon, aluminum, titanium, and zirconium is formed on the phosphor layer and the metal back layer is formed on the first treatment layer.

2. The metal back-attached phosphor screen as set forth in claim 1, wherein the oxide in the first treatment layer contains one kind or two or more kinds of alkali metal elements.

3. The metal back-attached phosphor screen as set forth in claim 1, wherein a content (per unit area, hereinafter same as this) of the oxide in the first treatment layer is 2 wt % to 20 wt % of a content of a phosphor in the phosphor layer.

4. The metal back-attached phosphor screen as set forth in claim 1, wherein the first treatment layer contains silicon dioxide (SiO₂), titanium oxide (TiO₂), and zirconium oxide (ZrO₂).

5. The metal back-attached phosphor screen as set forth in claim 4, wherein all following expressions hold when content percentages of respective elements of silicon, titanium, and zirconium in the first treatment layer are expressed as weight percentages and silicon dioxide is x1%, titanium oxide is y1%, and zirconium oxide is z1%.
70≦x1+y1<100
x1+0.5y1≦80
x1+y1+z1=100
(x1>0, y1>0, z1>0)

6. The metal back-attached phosphor screen as set forth in claim 1, further comprising a second treatment layer containing an oxide of one kind or two or more kinds of elements selected from the group consisting of silicon, aluminum, titanium, and zirconium on the metal back layer.

7. The metal back-attached phosphor screen as set forth in claim 6, wherein the oxide in the second treatment layer contains one kind or two or more kinds of alkali metal elements.

8. The metal back-attached phosphor screen as set forth in claim 6, wherein a content of the oxide in the second treatment layer, as a component weight per unit area of the metal back layer, is 4 μg/cm² to 40 μg/cm².

9. The metal back-attached phosphor screen as set forth in claim 1, further comprising a second treatment layer containing one kind or two or more kinds of inorganic oxides selected from the group consisting of silicon oxide, a silicon oxide containing one kind or two or more kinds of alkali metal elements, aluminum oxide, titanium oxide, and zirconium oxide on the metal back layer.

10. The metal back-attached phosphor screen as set forth in claim 9, wherein a content of the inorganic oxide in the second treatment layer, as a component weight per unit area of the metal back layer, is 4 μg/cm² to 40 μg/cm².

11. The metal back-attached phosphor screen as set forth in claim 6, wherein the second treatment layer contains silicon dioxide (SiO₂), titanium oxide (TiO₂), and zirconium oxide (ZrO₂).

12. The metal back-attached phosphor screen as set forth in claim 11, wherein all following expressions hold when content percentages of respective elements of silicon, titanium, and zirconium in the second treatment layer are expressed as weight percentages and silicon dioxide is x2%, titanium oxide is y2%, and zirconium oxide is z2%.
70≦x2+y2<100
x2+0.5y2≦80
x2+y2+z2=100
(x2>0, y2>0, z2>0)

13. A metal back-attached phosphor screen, comprising a phosphor layer and a metal back layer on an inner surface of a face plate, wherein a first treatment layer containing one kind or two or more kinds of inorganic oxides selected from the group consisting of silicon oxide, a silicon oxide containing one kind or two or more kinds of alkali metal elements, aluminum oxide, titanium oxide, and zirconium oxide is formed on the phosphor layer and the metal back layer is formed on the first treatment layer.

14. The metal back-attached phosphor screen as set forth in claim 13, wherein a content of the inorganic oxide in the first treatment layer is 2 wt % to 20 wt % of a content of a phosphor in the phosphor layer.

15. The metal back-attached phosphor screen as set forth in claim 13, further comprising a second treatment layer containing an oxide of one kind or two or more kinds of elements selected from the group consisting of silicon, aluminum, titanium, and zirconium on the metal back layer.

16. The metal back-attached phosphor screen as set forth in claim 15, wherein the oxide in the second treatment layer contains one kind or two or more kinds of alkali metal elements.

17. The metal back-attached phosphor screen as set forth in claim 15, wherein a content of the oxide in the second treatment layer, as a component weight per unit area of the metal back layer, is 4 μg/cm² to 40 μg/cm².

18. The metal back-attached phosphor screen as set forth in claim 13, further comprising a second treatment layer containing one kind or two or more kinds of inorganic oxides selected from the group consisting of silicon oxide, a silicon oxide containing one kind or two or more kinds of alkali metal elements, aluminum oxide, titanium oxide, and zirconium oxide on the metal back layer.

19. The metal back-attached phosphor screen as set forth in claim 18, wherein a content of the inorganic oxide in the second treatment layer, as a component weight per unit area of the metal back layer, is 4 μg/cm² to 40 μg/cm².

20. The metal back-attached phosphor screen as set forth in claim 15, wherein the second treatment layer contains silicon dioxide (SiO₂), titanium oxide (TiO₂), and zirconium oxide (ZrO₂).

21. The metal back-attached phosphor screen as set forth in claim 20, wherein all following expressions hold when content percentages of respective elements of silicon, titanium, and zirconium in the second treatment layer are expressed as weight percentages and silicon dioxide is x2%, titanium oxide is y2%, and zirconium oxide is z2%.
70≦x2+y2<100
x2+0.5y2≦80
x2+y2+z2=100
(x2>0, y2>0, z2>0)

22. A method of forming a metal back-attached phosphor screen, comprising:
forming a phosphor layer on an inner surface of a face plate;
forming a first treatment layer containing an oxide of one kind or two or more kinds of elements selected from the group consisting of silicon, aluminum, titanium, and zirconium on the phosphor layer; and
forming a metal back layer on the first treatment layer.

23. The method of forming a metal back-attached phosphor screen as set forth in claim 22, wherein the oxide in the first treatment layer contains one kind or two or more kinds of alkali metal elements.

24. A method of forming a metal back-attached phosphor screen, comprising:
forming a phosphor layer on an inner surface of a face plate;
forming a first treatment layer containing one kind or two or more kinds of inorganic oxides selected from the group consisting of silicon oxide, a silicon oxide containing one kind or two or more kinds of alkali metal elements, aluminum oxide, titanium oxide, and zirconium oxide on the phosphor layer; and
forming a metal back layer on the first treatment layer.

25. The method of forming a metal back-attached phosphor screen as set forth in claim 24, wherein the forming the first treatment layer comprises:
applying/drying a solution containing a component which produces the inorganic oxide by heating with water as a main solvent to form a lower coating film on the phosphor layer;
applying/drying a solution containing a component which produces the inorganic oxide by heating with an organic solvent as a main solvent to form an upper coating film on the lower coating film; and
heating a coating film in which the lower coating film and the upper coating film are stacked to form a layer mainly composed of the inorganic oxide.

26. The method of forming a metal back-attached phosphor screen as set forth in claim 24, wherein the forming the first treatment layer comprises:
hydrolyzing and polymerizing alkoxide (alcoholate) containing at least one kind of element selected from the group consisting of silicon (Si), titanium (Ti), and zirconium (Zr) in a solution;
applying/drying a solution containing oligomer obtained in hydrolyzing and polymerizing to form a coating film; and
heating the coating film to form a layer mainly composed of the inorganic oxide.

27. The method of forming a metal back-attached phosphor screen as set forth in claim 24, further comprising forming a second treatment layer containing one kind or two or more kinds of inorganic oxides selected from the group consisting of silicon oxide, a silicon oxide containing one kind or two or more kinds of alkali metal elements, aluminum oxide, titanium oxide, and zirconium oxide on the metal back layer.

28. The method of forming a metal back-attached phosphor screen as set forth in claim 27, wherein the forming the second treatment layer comprises:
hydrolyzing and polymerizing alkoxide (alcoholate) containing at least one kind of element selected from the group consisting of silicon (Si), titanium (Ti), and zirconium (Zr) in a solution;
applying/drying a solution containing oligomer obtained in hydrolyzing and polymerizing to form a coating film; and
heating the coating film to form a layer mainly composed of the inorganic oxide.

29. The method of forming a metal back-attached phosphor screen asset forth in claim 27, wherein informing the second treatment layer, a Sioₓ layer is formed by a sputtering method while a Si target is thermal sprayed with oxygen introduced.

30. An image display device, comprising:
a face plate;
a rear plate disposed facing the face plate;
numerous electron emitting elements formed on the rear plate; and
a phosphor screen formed on the face plate in such a way as to face the rear plate and emitting light by electron beams emitted from the electron emitting elements,
the phosphor screen being a metal back-attached phosphor screen as set forth in any one of claims 1 to 21.
